(19) United States
(12) Patent Application Publication
(10) Pub. No.: US 2015/0049270 A1
(43) Pub. Date: Feb. 19, 2015

(54) POWER SUPPLY OF AN ELECTRICALLY CONTROLLABLE LIQUID CRYSTAL GLAZING, AND METHOD FOR POWERING SUCH A GLAZING

(71) Applicants: Jingwei Zhang, Massy (FR); Hugues Chenneviere, Colombes (FR)

(72) Inventors: Jingwei Zhang, Massy (FR); Hugues Chenneviere, Colombes (FR)

(73) Assignee: Cardinal IG Company, Eden Prairie, MN (US)

(21) Appl. No.: 14/387,778

(22) PCT Filed: Mar. 29, 2013
(86) PCT No.: PCT/FR2013/050703

§ 371 Date: Sep. 24, 2014

(30) Foreign Application Priority Data
Mar. 30, 2012 (FR) 1252943

(51) Int. Cl. G02F 1/133; G02F 1/1335

(52) U.S. Cl. CPC G02F 1/13306; G02F 1/133553
USPC 349/33

(57) ABSTRACT

An electrically-controlled liquid crystal glazing unit can include a substrate carrying a liquid crystal element disposed between a first electrode and a second electrode connected to an electrical power supply. The liquid crystal element can transform from a diffusing state at zero voltage to a transparent and/or colored state at a sinusoidal AC voltage having an operating amplitude (V₀). In some examples, the electrical power supply is configured to apply a start-up voltage whose amplitude progressively increases from zero up to the operating amplitude (V₀) and/or a shut-down voltage (Vₛ(t)) whose amplitude decreases progressively from the operating amplitude (V₀) down to zero.

### TECHNICAL FIELD OF THE INVENTION

The technical field of the invention is that of electrically-controllable glazing units with variable light diffusion, and more particularly that of liquid crystal glazing units. The present invention relates to an electrically-controllable glazing unit and its electrical power supply, said glazing unit being capable of going from a diffusing state to a transparent state under the application, by the power supply, of an AC electrical voltage.

### BACKGROUND OF THE INVENTION

The degree of transparency of a liquid crystal glazing unit can be modified under the effect of a suitable electrical power supply. This degree is indeed linked directly to the amplitude of the voltage applied to the glazing unit. The capacity to see through such a glazing unit is thus controlled, which allows it to be reduced or even blocked for a certain time. Such glazing units are used for example as internal partitions between two rooms in a building, or between two train or aircraft compartments.

A liquid crystal glazing unit conventionally comprises a layer of liquid crystals disposed between a first electrode and a second electrode connected to an electrical power supply. The layer of liquid crystals is composed of pure liquid crystals and of a polymer. When the glazing unit is powered up by means of the power supply, the pure liquid crystals orient themselves along a preferential axis, and their optical index is equal to that of the polymer, which leads to a transparent state which allows viewing. With no applied voltage, in the absence of alignment of the liquid crystals, the discrepancy between the optical indices of the pure liquid crystals and of the polymer renders the glazing unit diffusing and prevents viewing. The company Saint-Gobain Glass markets notably such liquid crystal glazing units under the commercial name ‘Privalite’.

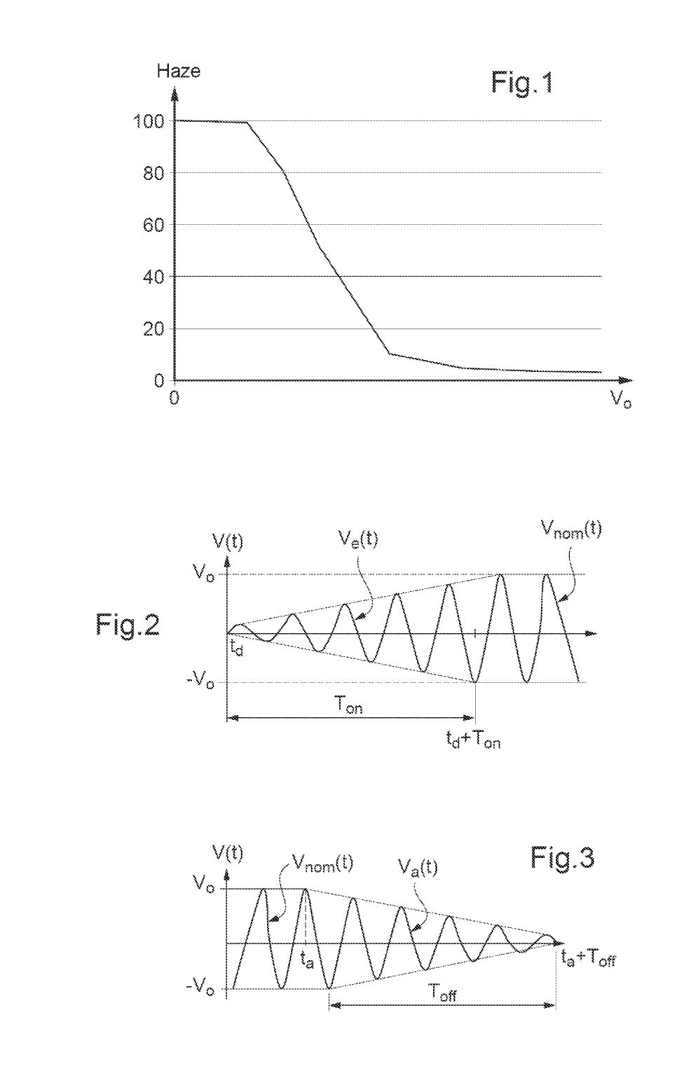

These glazing units are conventionally powered by an AC sinusoidal voltage V(t)=V₀ sin (2πf₀t), where the frequency f₀ is for example 50 Hz, and the amplitude V₀, referred to as operating amplitude, is typically of the order of a few tens of volts. The degree of transparency through the glazing unit is measured by the ‘haze level’. FIG. 1 shows the relationship between the haze level and the amplitude V₀. For V₀=0V, the haze level is close to 100% and the electrically-controllable liquid crystal glazing unit is in the diffusing state. For V₀ equal to a nominal amplitude Vₙₒₘ, the haze level is around 5%, and the glazing unit is in the transparent state. The nominal amplitude Vₙₒₘ depends on the intrinsic characteristics of the glazing unit, and notably on the layer of liquid crystals.

When the power supply is switched on, the glazing unit conventionally goes from a voltage of zero, corresponding to a diffusing state, to a voltage of amplitude V₀=Vₙₒₘ, corresponding to a transparent or virtually transparent state. Similarly, at the shut-down of the power supply, the glazing unit goes from the voltage V₀=Vₙₒₘ to a zero voltage.

The passage from the diffusing state to the transparent state, and conversely from the transparent state to the diffusing state, is immediate, an effect which may be considered as visually abrupt.

### GENERAL DESCRIPTION OF THE INVENTION

The object of the invention is to provide a solution for preventing the electrically-controllable liquid crystal glazing unit going abruptly from a diffusing state to a transparent state, and/or vice versa.

The invention is also applicable to the case in which an electrode is reflecting or semi-reflecting, or also to the case in which a reflecting or semi-reflecting element is mounted onto the substrate, and hence also provides a solution for preventing the liquid crystal glazing unit going abruptly from a diffusing state to a reflecting or semi-reflecting state, and/or vice versa.

Furthermore, the invention is also applicable to the case in which the layer of liquid crystals is colored, and hence also provides a solution for preventing the liquid crystal glazing unit going abruptly from a diffusing state to a colored state, and/or vice versa.

According to a first aspect, the invention essentially relates to an electrically-controllable liquid crystal glazing unit comprising a substrate (transparent or potentially colored, made of glass or polymer) carrying a liquid crystal element disposed between a first (transparent) electrode and a second electrode connected to an electrical power supply, the liquid crystal element being capable of going:
from a diffusing state in which the glazing unit is subjected to a zero voltage,
to a transparent and/or colored state, in which the glazing unit is subjected to a sinusoidal AC voltage with an amplitude referred to as operating amplitude, the electrical power supply being designed to apply to the glazing unit a start-up voltage whose amplitude progressively increases from zero up to the operating amplitude over a start-up period of time of at least 0.1 seconds (or even of at least 0.5 seconds or one second, and preferably less than one minute or even 30 seconds), beginning following the enabling of the electrical power supply, and/or a shut-down voltage whose amplitude progressively decreases from the operating amplitude down to zero, over a shut-down period of time of at least 0.1 seconds (or even of at least 0.5 seconds or one second, and preferably less than one minute or even 30 seconds), beginning following the shut-down of the electrical power supply.

Thanks to the invention, the electrically-controllable liquid crystal glazing unit is subjected to a voltage whose amplitude progressively increases and/or progressively decreases. Thus, the haze level progressively decreases or increases with the amplitude, which is visually more pleasing for the user, who can follow the transition with the naked eye. The start-up or shut-down period is indeed chosen so as to be adapted to the sensitivity of the eye.

Furthermore, since the start-up voltage begins at 0V, it also allows a high current peak to be prevented at the start-up of the power supply, which could damage the glazing unit. Indeed, thanks to the invention, the voltage at the terminals of the glazing unit at the start-up of the power supply does not go immediately from 0V to any given uncontrolled value V(t=0) in the range between −V₀ and V₀ (amplitude of the sinusoidal AC signal). The start-up current i(t=0), which progressively increases starting from zero, does not therefore damage the system of electrical distribution (bus bars), or the electrically-conducting layers, or even the liquid crystals.

Aside from the main features which have just been mentioned in the preceding paragraph, the glazing unit according to the invention can have one or more complementary features from amongst the following, considered individually or according to the technically possible combinations:
the amplitude of the start-up voltage increases linearly and/or the amplitude of the shut-down voltage decreases linearly. A linear increase is indeed considered as visually pleasing to the user, and is relatively simple to implement. The progressive increase is advantageously constant (continuous), rather than a stair function, and does not comprise any return to lower values already reached during the start-up period, nor any stabilization plateaus.
the start-up voltage is pseudo-sinusoidal, and/or the shut-down voltage is pseudo-sinusoidal.
the start-up voltage and the sinusoidal AC voltage have frequencies that are substantially identical, and/or the shut-down voltage and the sinusoidal AC voltage have frequencies that are substantially identical.
the frequency f₀ of the sinusoidal AC operating voltage is in the range between 40 Hz and 5 kHz.
the frequency of the start-up voltage, when the latter is pseudo-sinusoidal, is in the range between 40 Hz and 5 kHz, and/or the frequency of the shut-down voltage, when the latter is pseudo-sinusoidal, is in the range between 40 Hz and 5 kHz.
the start-up voltage is polynomial or linear, and/or the shut-down voltage is polynomial or linear.
at the end of the start-up period, the haze of the electrically-controllable glazing unit is less than 10%, and preferably less than or equal to 5%.
at the end of the start-up period, the light transmission (TL) of the glazing unit is at least 70%, or potentially 80% or 90%, and, in the presence of a reflecting element, the light reflection (RL) is at least 50% or even 70%.
the operating amplitude is less than or equal to 200 volts, and is typically a few tens of volts to 200 volts.
the power supply comprises means of adjustment of the start-up period.

According to a second aspect, the invention relates to a method for supplying electrical power to an electrically-controllable glazing unit such as previously described, comprising the following successive steps:
a step for activation of the power supply,
potentially, a step for adjustment of a start-up period,
a step for application to the glazing unit of a start-up voltage whose amplitude progressively increases from zero up to the operating amplitude, over the start-up period,
a step for disabling the power supply,
potentially, a step for application to the glazing unit of a shut-down voltage whose amplitude progressively decreases from the operating amplitude down to zero over a shut-down period of time of at least 0.1 seconds.

According to a third aspect, the invention relates to a device for supplying power to an electrically-controllable glazing unit according to the invention, comprising a switch connected to a programmable controller designed to progressively increase, via onboard software, the amplitude of the start-up voltage from zero up to the operating amplitude, over a start-up period of time beginning following the enabling of the switch.

The invention and its various applications will be better understood upon reading the description that follows and upon examining the figures which accompany it.

### BRIEF DESCRIPTION OF THE FIGURES

The figures are only presented by way of non-limiting example of the invention.

The figures show:

in FIG. 1, a curve representing the relationship between the haze level of an electrically-controllable glazing unit and the amplitude of the voltage applied to said glazing unit;

in FIG. 2, a timing diagram representing the voltage delivered by a power supply to an electrically-controllable glazing unit according to a first embodiment of the invention, at the start-up of said power supply;

in FIG. 3, a timing diagram representing the voltage delivered by the power supply to the glazing unit in FIG. 2, at the shut-down of said power supply;

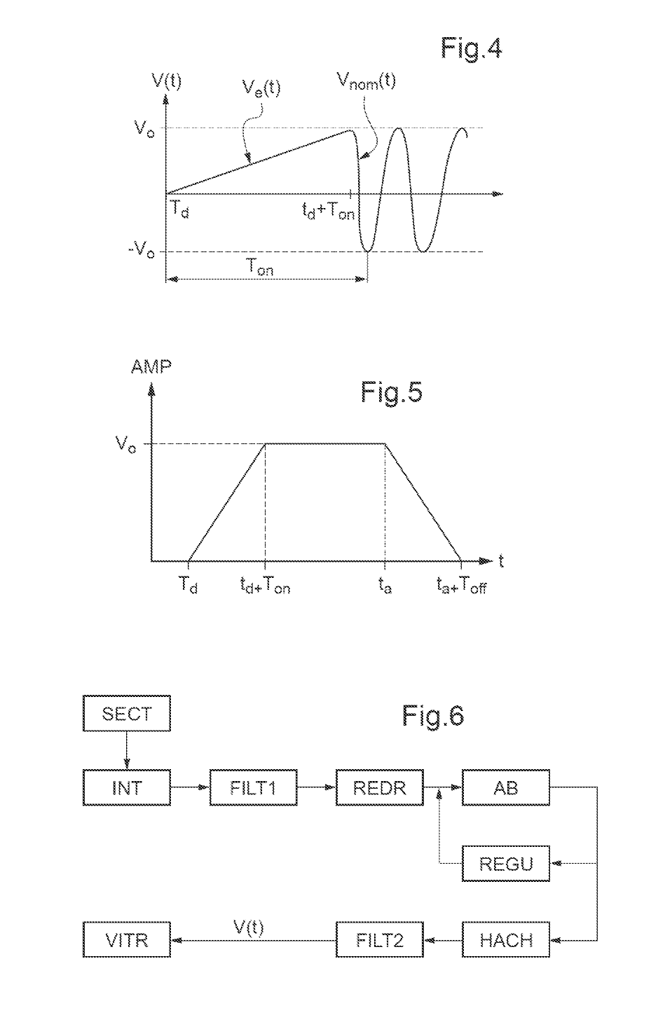

in FIG. 4, a timing diagram representing the voltage delivered by a power supply to an electrically-controllable glazing unit according to a second embodiment of the invention, at the start-up of said power supply;

in FIG. 5, a timing diagram representing the amplitude of the voltage delivered by a power supply to an electrically-controllable glazing unit according to the first or the second embodiment of the invention;

in FIG. 6, a schematic block diagram of a power supply for an electrically-controllable glazing unit according to the first embodiment of the invention.

### DETAILED DESCRIPTION OF AT LEAST ONE EMBODIMENT OF THE INVENTION

The invention relates to a power supply ALIM for an electrically-controllable liquid crystal glazing unit VITR. In the following part of the description, the voltage delivered by the power supply ALIM to the glazing unit VITR is denoted V(t).

As previously explained, the glazing unit VITR comprises a layer of liquid crystals disposed between a first electrode and a second electrode. In the embodiment described, the first electrode and the second electrode are transparent and on transparent substrates (typically polymers or glasses) that could potentially be tinted, so the glazing unit VITR is able to go from a diffusing state to a transparent state (or quasi-transparent state) under the effect of the voltage V(t). The glazing unit VITR is then:
in the diffusing state when it is not subjected to any voltage, in other words when the voltage V(t) is zero, and
in the transparent state (the degree of transparency is for example at least 70%) when the voltage V(t) is a sinusoidal AC voltage.
We then have: V(t)=Vₙₒₘ(t)=V₀ sin (2πf₀t), where:
   V₀ is the amplitude of the sinusoidal AC voltage Vₙₒₘ(t), said amplitude V₀ being referred to as operating amplitude in the following part of the description. V₀ is conventionally equal to a few tens of volts to 200V. V₀ is directly linked to the haze of the glazing unit VITR, as previously explained. V₀ is therefore advantageously chosen such that, at this amplitude, the haze is less than 10%, and preferably less than or equal to 5%.
   f₀ is the frequency of the sinusoidal AC voltage Vₙₒₘ(t). Since the power supply ALIM is conventionally connected to the line supply, f₀ is conventionally equal to 50 or 60 Hz.

It is noted that, in another embodiment, the first electrode is not transparent but reflecting or semi-reflecting. The glazing unit VITR is then capable of going from a diffusing state to a reflecting or semi-reflecting state, and vice versa.

As a variant, the layer of liquid crystals is colored, for example by the addition of dichroic colorant as is conventionally practised. Furthermore, the substrate or substrates may be coated, on the main face opposite to the face with the layer of liquid crystals, with various functional elements: antireflective layer, protective layer, etc. Furthermore, on the side of the main face opposite to the face with the layer of liquid crystals, the substrate or substrates may be laminated with glass inserts via lamination interlayers.

In order to prevent the glazing unit VITR going abruptly from one state to another, the power supply ALIM is capable of supplying one or more transition voltage(s) Vₑ(t), Vₛ(t), preventing the glazing unit VITR abruptly being subjected to a voltage going from a zero voltage to the sinusoidal AC voltage Vₙₒₘ(t), and/or conversely from the sinusoidal AC voltage Vₙₒₘ(t) to a zero voltage. The power supply ALIM is thus designed to supply:
a start-up voltage Vₑ(t) over a start-up period of time Tₒₙ beginning following the activation of the power supply ALIM, whose amplitude progressively increases from zero up to the operating amplitude V₀. In a first embodiment, the start-up voltage Vₑ(t) is a pseudo-sinusoidal voltage at the frequency f₀ of the sinusoidal AC voltage Vₙₒₘ(t). Then, at the end of the start-up period Tₒₙ, the power supply ALIM then delivers the sinusoidal AC voltage Vₙₒₘ(t).
and/or a shut-down voltage Vₛ(t) over a shut-down period of time T_{off} beginning following the disabling of the power supply ALIM, whose amplitude decreases progressively from the operating amplitude V₀ down to zero over the shut-down period T_{off}. In one embodiment, the shut-down voltage Vₛ(t) is a pseudo-sinusoidal voltage at the frequency f₀ of the sinusoidal AC voltage Vₙₒₘ(t).

The voltage V(t) delivered by the power supply, according to one embodiment of the invention, is shown in FIGS. 2 and 3. FIG. 2 relates to the start-up of the power supply ALIM, in other words the case in which the glazing unit VITR is initially in the diffusing state and it is desired for it to go into the transparent state, whereas FIG. 3 relates to the shut-down of the power supply ALIM, in other words when it is desired for the glazing unit VITR to return from the transparent state to the diffusing state.

The start-up of the power supply ALIM takes place at time t=t_{d}. For times less than t=t_{d}, therefore V(t)=0. During the start-up period Tₒₙ, we have: V(t)=Vₑ(t). Then, at the end of the start-up period Tₒₙ, we have: V(t)=Vₙₒₘ(t).

The shut-down of the power supply ALIM takes place at time t=tₐ. During the shut-down period T_{off} beginning at t=tₐ, we have: V(t)=Vₛ(t). Then, at the end of the shut-down period T_{off}, we have: V(t)=0.

In the embodiment shown in FIGS. 2 and 3:
the start-up voltage Vₑ(t) and the shut-down voltage Vₛ(t) are pseudo-sinusoidal;
the amplitude of the start-up voltage Vₑ(t) and the amplitude of the shut-down voltage Vₛ(t) increase linearly;
the start-up voltage Vₑ(t), the shut-down voltage Vₛ(t), and the sinusoidal AC voltage Vₙₒₘ(t) have frequencies that are substantially identical. It is noted that to speak of the frequency of a pseudo-periodic signal is an abuse of language aimed at lightening the text, and that it is naturally intended to speak of pseudo-frequency.

The features listed hereinabove have the advantage of being simple to implement, and of ending up with a continuity in terms of frequency and of amplitude between the start-up voltage Vₑ(t) and the sinusoidal AC voltage Vₙₒₘ(t), on the one hand, and between the sinusoidal AC voltage Vₙₒₘ(t) and the shut-down voltage Vₛ(t), on the other.

In a second embodiment described in FIG. 4, the start-up voltage Vₑ(t) is linear. The visual effect of progressive transparency is identical to the embodiment described in FIG. 2, and this embodiment furthermore has the advantage of being particularly simple to implement. In other embodiments not shown, the start-up voltage Vₑ(t) takes the form of a bell or, alternatively, of a parabola.

FIG. 5 illustrates the variation of the amplitude AMP of the voltage V(t) as a function of time, when the power supply ALIM comprises the function “smooth start” and the function “smooth stop”, in other words when it is designed to deliver a start-up voltage Vₑ(t) and a shut-down voltage Vₛ(t) with a progressive amplitude. It is observed that, at time t=t_{d}, in other words at the start-up of the power supply ALIM, the amplitude of the voltage V(t) increases linearly until it reaches the operating amplitude V₀ at time t=tₐ+Tₒₙ. Then, at time t=tₐ, in other words at the shut-down of the power supply ALIM, the amplitude of the voltage V(t) decreases linearly from the operating amplitude V₀ down to zero, a value which it reaches at time t=tₐ+T_{off}.

FIG. 6 shows a schematic block diagram of the power supply ALIM, designed to supply the start-up voltage Vₑ(t) and the shut-down voltage Vₛ(t). Such a power supply ALIM is known to those skilled in the art, and one embodiment is recalled hereinbelow. This electrical power supply ALIM possesses a function known as “smooth start”/“smooth stop” which allows the start-up and the shut-down of the glazing unit VITR to be controlled by progressively increasing and progressively decreasing the amplitude of the voltage delivered to the glazing unit. This leads to a soft, controlled transition between the diffusing state and the transparent state, providing a better visual sensation with respect to an abrupt change of state.

The power supply ALIM is connected to an electrical supply system SECT, generally the line supply whose frequency is equal to 50 or 60 Hz, and comprises the following elements:
a switch INT, at the input of the power supply ALIM, which allows the power supply ALIM to be connected to the electrical supply system SECT and thus allows the power supply ALIM to be operated;
a line supply filter FILT1 which is an obligation of international standards and which allows it to be ensured that the power supply ALIM does not generate any interference over the household electrical supply system SECT;
a rectifier REDR which allows a DC voltage to be obtained, starting from the sinusoidal signal distributed by the electrical supply system SECT;
a voltage reducer AB and a programmable controller REGU, which form a switch-mode power supply. The conjugated action of the voltage reducer AB and of the programmable controller REGU allow a DC voltage to be obtained at a specific value;
a chopper HACH which allows said DC signal thus generated to be transformed back into a sinusoidal voltage;
an output filter FILT2 which allows the unnecessary harmonics to be eliminated and thus the signal applied to the liquid crystal glazing unit VITR, in other words V(t), to be purified.

At the start-up, the action on the switch INT powers the programmable controller REGU. The programmable controller REGU is designed to progressively increase the output voltage from 0V to its nominal value, over a period of time set in an onboard software application: the start-up period Tₒₙ.

The start-up period Tₒₙ may be programmed as desired, depending on the desired transition effect between the diffusing state and the transparent state. A few pseudo-periods of the start-up voltage Vₑ(t), typically 5, are sufficient. For a frequency f₀=50 Hz, 25 start-up pseudo-periods are equivalent to 0.5 seconds. For a pleasing visual effect, it is advantageously desired for the start-up period Tₒₙ to be equal to at least half a second, or even at least one second.

The extinction of the power supply ALIM via a new action on the switch INT, switches off the programmable controller REGU. This action disables the control of the output voltage. The amplitude of the shut-down voltage Vₛ(t) thus decreases progressively over a shut-down period of time T_{off}. The shut-down period T_{off} is determined by the components of the output filter FILT2 and the energy stored in the glazing unit VITR. The liquid crystal glazing unit VITR indeed plays an active role, in oscillation with components of the output filter FILT2.

Advantageously, the components of the power supply are chosen in such a manner that the shut-down period T_{off} is advantageously at least half a second, or even at least one second, for a pleasing visual effect.

It is noted that this power supply also allows the performance of the liquid crystal glazing unit VITR to be guaranteed by limiting the damage associated with the high electrical current at the start-up and at shut-down. The lifetime of the glazing unit VITR is thus extended.

1. An electrically-controlled liquid crystal glazing unit comprising:
a substrate carrying a liquid crystal element disposed between a first electrode and a second electrode connected to an electrical power supply, the liquid crystal element being capable of going:
from a diffusing state in which the glazing unit is subjected to a zero voltage,
to at least one of a transparent state and a colored state, in which the glazing unit is subjected to a sinusoidal AC voltage (Vₙₒₘ(t)) having an operating amplitude (V₀),
wherein the electrical power supply is configured to apply to the glazing unit at least one of:
a start-up voltage (Vₑ(t)) whose amplitude progressively increases from zero up to the operating amplitude (V₀), over a start-up period of time (Tₒₙ) of at least 0.1 seconds beginning following the activation of the electrical power supply, and
a shut-down voltage (Vₛ(t)) whose amplitude decreases progressively from the operating amplitude (V₀) down to zero, over a shut-down period of time (T_{off}) of at least 0.1 seconds beginning following the shut-down of the electrical power supply.

2. The electrically-controlled glazing unit as claimed in claim 1, wherein the electrical power supply is configured to at least one of linearly increase the amplitude of the start-up voltage (Vₑ(t)) and linearly decrease the amplitude of the shut-down voltage (Vₛ(t)).

3. The electrically-controlled glazing unit as claimed in claim 1, wherein at least one of the start-up voltage (Vₑ(t)) and the shut-down voltage (Vₛ(t)) is pseudo-sinusoidal.

4. The electrically-controlled glazing unit as claimed in claim 3, wherein at least one of
the pseudo-sinusoidal start-up voltage (Vₑ(t)) and the sinusoidal AC voltage (Vₙₒₘ(t)) have frequencies that are substantially identical, and
the shut-down voltage (Vₛ(t)) and the sinusoidal AC voltage (Vₙₒₘ(t)) have frequencies that are substantially identical.

5. The electrically-controlled glazing unit as claimed in claim 3, wherein the frequency of the pseudo-sinusoidal voltage is in the range between 40 Hz and 5 kHz.

6. The electrically-controlled glazing unit as claimed in claim 1, wherein the start-up voltage (Vₑ(t)) is one of polynomial and linear.

7. The electrically-controlled glazing unit as claimed in claim 1, wherein, at the end of the start-up period (Tₒₙ), the haze of the electrically-controlled glazing unit is less than 10%.

8. The electrically-controlled glazing unit as claimed in claim 1, wherein the electrical power supply comprises means for adjusting the start-up period (Tₒₙ).

9. A method for supplying electrical power to a liquid crystal electrically-controlled glazing unit comprising:
enabling an electrical power supply connected to at least one of a first electrode and a second electrode between which is disposed a liquid crystal element configured to transform from a diffusing state to at least one of a transparent state and a colored state; and
applying to the glazing unit a start-up voltage (Vₑ(t)) whose amplitude progressively increases from zero up to a sinusoidal AC operating amplitude (V₀) over a start-up period of time (Tₒₙ) of at least 0.1 seconds.

10. The method as claimed in claim 9, further comprising adjusting the start-up period (Tₒₙ).

11. The method as claimed in claim 9, further comprising:
disabling of the electrical power supply; and
applying to the glazing unit a shut-down voltage (Vₛ(t)) whose amplitude decreases progressively from the operating amplitude (V₀) down to zero over a shut-down period of time (T_{off}) of at least 0.1 seconds.

12. A device for supplying power to an electrically-controlled glazing unit comprising:
a switch connected to a programmable controller that is configured to control an electrical power supply connected to at least one of a first electrode and a second electrode between which is disposed a liquid crystal element configured to transform from a diffusing state to at least one of a transparent state and a colored state,
wherein the controller is configured to progressively increase, via onboard software, an amplitude of a start-up voltage (Vₑ(t)) from zero up to a sinusoidal AC operating amplitude (V₀), over a start-up period of time (Tₒₙ) of at least 0.1 seconds beginning following the enabling of the switch.

13. The electrically-controlled glazing unit as claimed in claim 1, wherein the electrical power supply is configured to apply to the glazing unit both:
the start-up voltage (Vₑ(t)) whose amplitude progressively increases from zero up to the operating amplitude (V₀), over the start-up period of time (Tₒₙ), and
the shut-down voltage (Vₛ(t)) whose amplitude decreases progressively from the operating amplitude (V₀) down to zero, over the shut-down period of time (T_{off}).

14. The electrically-controlled glazing unit as claimed in claim 13, wherein the electrical power supply is configured to both linearly increase the amplitude of the start-up voltage (Vₑ(t)) and linearly decrease the amplitude of the shut-down voltage (Vₛ(t)).
